(19) United States
(12) Patent Application Publication
(10) Pub. No.: US 2026/0036893 A1
(43) Pub. Date: Feb. 5, 2026

(54) POWER PEDESTAL WITH GHOST LIGHTING PROJECTION DEVICE

(71) Applicant: EATON INTELLIGENT POWER LIMITED, DUBLIN 4 (IE)

(72) Inventors: Paul D. Seff, Williamsburg, VA (US); Mark W. Mosser, Williamsburg, VA (US); Greg Storck, Williamsburg, VA (US)

(73) Assignee: EATON INTELLIGENT POWER LIMITED, DUBLIN 4 (IE)

(21) Appl. No.: 19/265,197

(22) Filed: Jul. 10, 2025

Related U.S. Application Data
(60) Provisional application No. 63/677,127, filed on Jul. 30, 2024.

(51) Int. Cl. G03B 21/20; G03B 21/14

(52) U.S. Cl. CPC G03B 21/208; G03B 21/145

(57) ABSTRACT

An improved power pedestal includes a ghost lighting projection device. The ghost lighting projection device is separate from an illumination lens that provides lighting to illuminate the area around the power pedestal. The ghost lighting projection device can include customizable text and/or imagery, thus enabling a user to provide increased differentiation of the area where the power pedestal is located, such as a marina or a specific slip at the marina.

### CROSS REFERENCE TO RELATED APPLICATIONS

This application claims priority to U.S. Provisional Patent Application Ser. No. 63/677,127, filed on Jul. 30, 2024 and titled “POWER PEDESTAL WITH GHOST LIGHTING PROJECTION DEVICE”, the disclosure of which is incorporated herein by reference.

### FIELD OF THE INVENTION

The disclosed concept relates generally to power pedestals, and in particular, to lighting devices of power pedestals.

### BACKGROUND OF THE INVENTION

Power pedestals are outdoor electrical enclosures often used to provide utility power distribution in settings such as marinas and recreational vehicles (RVs). Power pedestals typically comprise an upstanding housing with a base. The housing is made from a weather-resistant material and is designed to enclose the electrical components that enable the power pedestal to provide power to target devices. Such electrical components can include, for example and without limitation, circuit breakers and power receptacles. In particular, the housing and pedestal are structured to protect the electrical components from the environment and to prevent electrical faults caused by moisture.

In marina settings in particular, power pedestals provide important lighting functionality. For example and without limitation, the illumination provided by power pedestals enables pedestrians on dock walkways to clearly see the edges of the docks/slips even when there is low ambient light. Although many power pedestals provide satisfactory lighting, there is always room for innovation in power pedestal lighting features.

The present invention thus provides an improved lighting solution for power pedestals.

### SUMMARY OF THE INVENTION

These needs, and others, are met by a power pedestal that includes a ghost lighting projection device. The ghost lighting projection device is separate from an illumination lens that provides lighting to illuminate the area around the power pedestal. The ghost lighting projection device can include customizable text and/or imagery, thus enabling a user to provide increased differentiation of the area where the power pedestal is located, such as a marina or a specific slip at the marina.

In accordance with one aspect of the disclosed concept, a power pedestal comprises: a housing with a base, a roof that is coupled to the housing, an electrical bus for connecting to a power supply, and a ghost lighting projection device. The ghost lighting projection device is connected to the electrical bus and mounted on the roof such that, when the base is sitting on a ground surface, the ghost lighting projection device is disposed above the ground surface. The ghost lighting projection device is structured such that, when activated, the ghost lighting projection device projects an illuminated image on whichever surface a lens of the ghost lighting projection device is facing.

### BRIEF DESCRIPTION OF THE DRAWINGS

A full understanding of the invention can be gained from the following description when read in conjunction with the accompanying drawings in which:

FIG. 1 is a perspective view of an improved power pedestal with a ghost lighting projection device, in accordance with an example embodiment of the disclosed concept; and

FIG. 2 shows a non-limiting example of a projected illuminated image produced by the ghost lighting projection device of FIG. 1.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically state.

As employed herein, the term “number” shall mean one or an integer greater than one (i.e., a plurality).

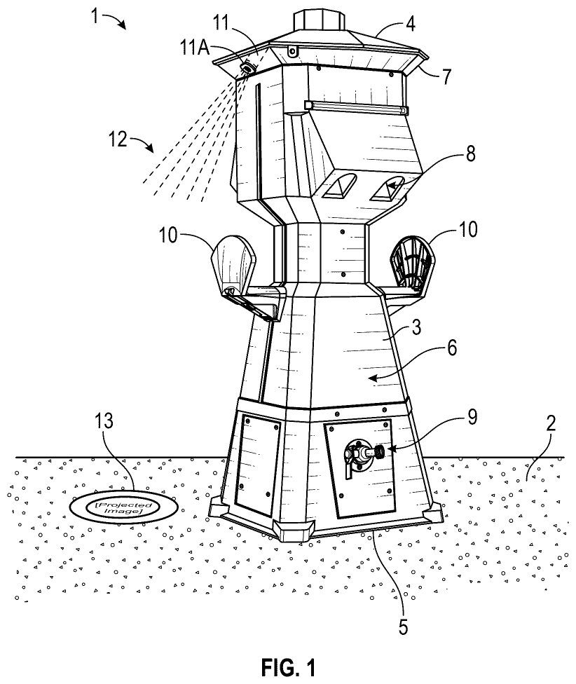

FIG. 1 shows an improved power pedestal 1 that includes a ghost lighting projection device, in accordance with an exemplary embodiment of the disclosed concept. The improved power pedestal 1 disclosed herein provides increased visibility functionality relative to known power pedestals. The power pedestal 1 is shown standing on a ground surface 2 in FIG. 1. The power pedestal 1 comprises a housing 3 with a removable roof 4 that encloses various electrical components which enable the power pedestal 1 to connect to a power source. In particular, conductors connected to a power supply can be fed through a base 5 of the housing 3 and connected to an electrical bus 6 (not visible in the figures) provided in the interior of the housing 3.

In FIG. 1, the power pedestal 1 is shown including an illumination lens 7 as part of the roof 4. The illumination lens 7 is structured to illuminate the area around the power pedestal 1 in order to increase visibility of the area around the power pedestal 1 in limited visibility conditions, such as nighttime. The specific embodiment of the illuminations lens 7 shown in FIG. 1 is a 360-degree illumination lens. That is, the illumination lens 7 surrounds the entire perimeter of the roof 4 so as to provide 360 degrees of illumination when an internal light source is powered on. The power pedestal 1 further includes a number of power receptacles 8. There are several well-known features that can be made available in power pedestals, and it is noted that the power pedestal 1 can provide varying combinations of features in addition to or instead of the illumination lens 7 and power receptacles 8 shown in FIG. 1 without departing from the scope of the disclosed concept, including but not limited to: a water supply spout 9, a number of cable management hooks 10, an internet connection port, and a cable TV connection port.

The disclosed power pedestal 1 represents an improvement over existing power pedestals due to the inclusion of a ghost lighting projection device 11 that is not found in known power pedestals. As used herein, the term “ghost lighting” refers to LED light projection. The ghost lighting projection device 11 is structured to be mounted on the roof 4 near the illumination lens 7 such that the ghost lighting projection device 11 is positioned above the ground surface 2 on which the base 5 rests. In one non-limiting embodiment of the power pedestal 1 as shown in FIG. 1, the ghost lighting projection device 11 is disposed primarily within the interior of the roof 4 such that only a projection lens 11A of the ghost lighting projection device 11 is situated on the exterior of the roof 4. In this particular embodiment of the power pedestal 1, the illumination lens 7 comprises an opening structured to receive the projection lens 11A, thus enabling the projection lens 11A to be situated on the exterior of the roof 4. In FIG. 1, the portion of the ghost lighting projection device 11 disposed within the interior of the roof 4 is drawn in broken line, while the projection lens 11A is drawn in solid line. The ghost lighting projection device 11 is configured to be selectively activated by a user and is structured to be rotated.

When activated, the ghost lighting projection device 11 emits light 12 (represented by broken lines in FIG. 1) and projects, via ghost lighting, an illuminated image 13 on whatever surface is faced by the lens of the ghost lighting projection device 11. In one non-limiting example and as shown in FIG. 1, the ghost lighting projection device 11 faces the ground surface 2 adjacent the base 5, so the illuminated image 13 is produced on the ground surface 2 near the base 5. However, the ghost lighting projection device 11 can be rotated to instead project the illuminated image 13 onto a surface other than the adjacent ground surface 2, such as a nearby vertical structure.

The ghost lighting projection device 11 can be configured to make the image 13 contain any text, symbol, logo, etc. provided by a user. The image 13 can provide, for example and without limitation, the name of a marina, an advertising sponsor's company name, an event name, etc. It is expected that in a marina setting, some marina owners would use the image 13 for advertising, brand recognition, or slip numbering purposes when the power pedestal 1 is installed at a dock or slip. The ghost lighting projection device 11 provides increased differentiation of the area where the power pedestal 1 is located, such as a marina or a specific slip at the marina, which is especially useful in nighttime or other limited visibility conditions.

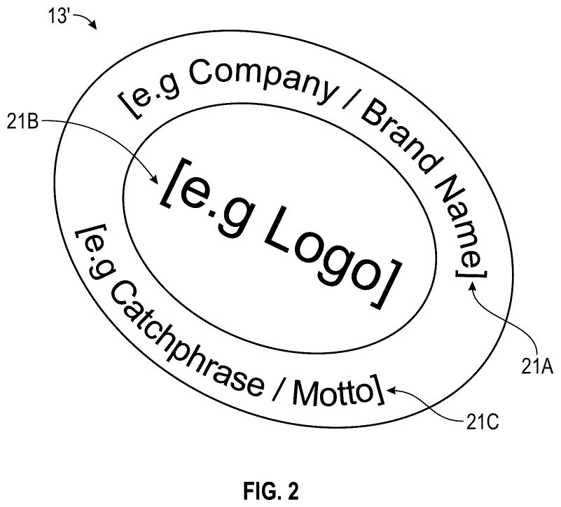

FIG. 2 shows a projected image 13′ that can be produced by the ghost lighting projection device 11 when a non-limiting example template is used in the ghost lighting projection device 11. The non-limiting example template used to create the projected image 13′ includes company/brand name text 21A, a logo 21B, and catchphrase/motto text 21C.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A power pedestal, the power pedestal comprising:
a housing with a base;
a roof that is coupled to the housing;
an electrical bus for connecting to a power supply; and
a ghost lighting projection device connected to the electrical bus and mounted on the roof such that, when the base is sitting on a ground surface, the ghost lighting projection device is disposed above the ground surface,
wherein the ghost lighting projection device is structured such that, when activated, the ghost lighting projection device projects an illuminated image on whichever surface a lens of the ghost lighting projection device is facing.

2. The power pedestal of claim 1,
wherein the ghost lighting projection device is structured to be rotated.

3. The power pedestal of claim 1,
wherein the roof includes an illumination lens,
wherein the illumination lens is structured to illuminate the area around the power pedestal when an internal light source is powered on.

4. The power pedestal of claim 3,
wherein the illumination lens surrounds the entire perimeter of the roof,
wherein the illumination lens is structured to provide 360-degree lighting when the internal light source is powered on.

5. The power pedestal of claim 1,
wherein the illuminated image includes text.
